(19) United States
(12) Patent Application Publication
(10) Pub. No.: US 2024/0107638 A1
(43) Pub. Date: Mar. 28, 2024

(54) DETERMINING A TARGET PROCESSING STATE OF A COOKING PRODUCT TO BE TREATED

(71) Applicant: BSH Hausgeräte GmbH, Munich (DE)

(72) Inventors: Hans-Martin Eiter, Kirchweidach (DE); Josef Pfeiffer, Übersee (DE); Eckehard Reinwald, Ottobrunn (DE)

(21) Appl. No.: 17/768,496

(22) PCT Filed: Oct. 20, 2020
(86) PCT No.: PCT/EP2020/079485

§ 371 Date: Apr. 13, 2022

(30) Foreign Application Priority Data
Oct. 29, 2019 (DE) 10 2019 216 682.2

(51) Int. Cl. H05B 6/64; A47J 36/32; G06V 20/68

(52) U.S. Cl. CPC H05B 6/6447; A47J 36/321; G06V 20/68

(57) ABSTRACT

In a method for determining a target processing state of a cooking product to be treated using a cooking appliance, a set of images of the cooking product in different processing states is provided to a user, with measurement signatures being stored for the images. When the user selects one of the images, the cooking appliance assumes a corresponding one of the measurement signatures associated with the selected image as a target measurement signature.

The invention relates to a method for setting a target processing state of at least one cooking product to be treated by means of a cooking appliance. The invention also relates to a method for operating a cooking appliance in which a cooking operation is carried out until an assumed target processing state is reached. The invention further relates to a cooking appliance having a cooking chamber, at least one sensor connected to the cooking chamber, and a data processing facility, wherein the cooking appliance is designed to carry out the method. The invention also relates to a computer program product. The invention can be applied particularly advantageously to ovens with at least one cooking chamber camera, in particular for determining or selecting a degree of browning of a cooking product.

Previous proposals for describing a target degree of browning of foodstuffs comprise levels such as “light”, “medium”, “dark”, a scale value (for example between 0% and 100%) or a color gradient (for example from white, through brown, to black). However, the browning and the crispness associated therewith are highly individual and subjective characteristics of a foodstuff, which disadvantageously often cannot be described adequately with “light”, “medium” or “dark”, for example. Especially for non-homogeneous foodstuffs with different surface components such as pizza, gratin or cake, it is in most cases not possible to assign a uniform color or lightness value meaningfully to the entire dish; in other words, a surface with different colored components cannot be assigned a single browning value (color or discrete value) as the target value. Moreover, the target degree of browning is specific to groups of dishes: for example, a biscuit dough with a “medium” degree of browning has different color and lightness values than a chicken with a “medium” degree of browning. Even within a category of dishes, for example within chickens or cakes in molds, different recipes call for different target values, for example chicken seasoned with salt and pepper versus seasoned with soy sauce.

EP 3 477 206 A1 discloses a cooking appliance with a cooking chamber, an image generation apparatus for acquiring an image of a foodstuff within the cooking chamber, a data processing apparatus which communicates with the image generation apparatus and comprises a software module which is configured to receive the acquired image from the image generation apparatus and calculate a degree of browning, and a user interface which is configured to display a visual scale of the degree of browning. The cooking appliance can be equipped with a selection apparatus which is configured to enable a user to set a target degree of browning for the foodstuff. The user interface can be configured to display a target image of the foodstuff based on the target degree of browning.

US 20130092145 A1 discloses an oven, comprising: a cooking chamber which is configured to receive a food product, a user interface which is configured to display information assigned to processes which are used to cook the food product; a first energy source which provides a primary heating of the food product placed in the cooking chamber; a second energy source which browns the food product; and a cooking controller which is coupled during operation to the first and second energy source, wherein the cooking controller contains a processing circuit which is configured to enable an operator to make a browning control selection via the user interface by providing operator commands to a selected control console which is displayed on the user interface, wherein the selected control console is selected on the basis of a cooking mode of the oven and wherein the browning control selection provides control parameters in order to conduct the supply of heat to the food product via the second energy source. The cooking mode can be one of a first mode, in which the operator can select several of the control parameters including air temperature, air speed and time, and a second mode, in which the operator can select a degree of browning and the control parameters are determined automatically according to the selected level of browning.

WO 2009/026895 A2 discloses a method for setting a work program to be executed in an interior of a cooking appliance, comprising at least one cooking program and/or at least one cleaning program in which at least one parameter of a multiplicity of parameters can be set via at least one display and operating facility, characterized in that the parameter, the values of the parameter that can be set and the set value are visualized at least for a time on the display and operating facility. In one variant, the change in the parameter is displayed visually at least at certain times, continuously or in steps, during execution of the work program. Another variant is that each set parameter can be stored in the form of its visual representation, in particular in an image gallery, or printed out, in particular for a cookbook, a hygiene certificate or a menu, or sent, in particular wirelessly, preferably in each case with specification of the selected work program.

The object of the present invention is to overcome the disadvantages of the prior art at least partially and in particular to provide a particularly intuitively operable and comprehensible option for setting a processing state of a cooking product, in particular of the degree of browning or roasting of cooking product surfaces.

This object is achieved in accordance with the features of the independent claims. Advantageous embodiments are the subject matter of the dependent claims, the description and the drawings.

The object is achieved by a method for setting or determining a target processing state of at least one cooking product to be treated by means of a cooking appliance, in which
a set of images of a cooking product in different processing states is provided to a user for selection, wherein respective measurement signatures are stored for the images, and
if a user selects one of the images, the cooking appliance assumes the measurement signature associated with the selected image as the target measurement signature.

In this way, the advantage is achieved that instead of abstract scales (degree of browning, color value, etc.) which are difficult to understand, processing results such as browning, change of color, rising, etc. can be visualized in a manner which is easy for a user to understand and are offered for selection. The user need only select the image from the set of images that most closely approximates the desired processing state (in other words the target processing state), and the associated target measurement signature is assumed for the cooking process without the user having to concern himself with a further definition of the target processing state. Here, use is made of the fact that the “translation” of the selected image into a target state which is capable of being technically evaluated is defined by the target measurement signature. The assumption of the target measurement signature thus corresponds to determining, setting or selecting the target processing state.

A “target processing state” is understood in particular to mean a target state of a cooking product which is considered desirable by a user, for example in relation to:
a surface color of the cooking product (for example a degree of browning, a change of color (for example from light green to dark green, from green to brown, etc.), also where applicable in certain regions,
a change in lightness of the cooking product, also where applicable in certain regions,
a surface quality, for example a cracking of crust, a formation of bubbles, etc.,
a volume of the cooking product (for example in the case of rising yeast dough) and/or
a cooking product temperature, etc.

A “measurement signature” is understood in particular to mean at least one measurement value which maps the processing state (for example an averaged degree of browning, a cooking chamber temperature, an oxygen content in the cooking chamber, etc.), a group of measurement values (for example a pixel-based image of the cooking product) and/or at least one value derived or calculated therefrom (for example a histogram of pixel values, a degree of browning, etc.). The measurement signature therefore corresponds to a representative of a processing state which can be determined by means of measurement technology, in particular by means of the cooking appliance. The measurement signature can additionally have at least one state variable of the cooking appliance, for example an appliance type, a set heating type, a preheating, a door opening state (for example door open/door closed), etc. The measurement signature can additionally be based for example on a food type predetermined by a user or by means of a program, etc.

The assumed target measurement signature can be compared with an actual measurement signature during a cooking process. The measurement signature can be determined according to generally known methods. Consequently, the measurement signature can correspond to a single value or be present as an n-tuple or n-dimensional vector which has been calculated from several measurement values.

In one development, the cooking appliance is a household cooking appliance. In one development, the cooking appliance has a cooking chamber. In one development, the cooking appliance is an oven, microwave appliance, steam treatment appliance or any combination thereof, for example an oven with microwave functionality.

The cooking product to be treated can be or comprise for example at least one food, foodstuff and/or dish.

The set of images of the cooking product can be present in particular as an image sequence comprising images of the cooking product which have been acquired with an increasing processing duration. The image sequence can be present for example as a time-lapse sequence.

The set of images and optionally also the associated measurement signatures can already have been generated for example by a manufacturer of the cooking appliance, a manufacturer of the cooking product, publishers of cookbooks/recipes, a user of the cooking appliance himself and or by other users (“user community”).

The set of images being provided for selection can comprise the images being displayed on a screen where they can be selected by the user. It is particularly operator-friendly if the images are offered on a touch-sensitive screen and can be selected by tapping. The images can be displayed on the screen for example simultaneously or by scrolling, swiping, etc. The screen can be a screen of the cooking appliance or a screen of a user terminal device such as a smartphone, tablet PC, laptop, desktop PC, intelligent accessory (for example an intelligent clock or smart watch, etc.). The image selection can therefore take place generally only on the cooking appliance, only on a user terminal device or on both.

In one development, the measurement signatures assigned to the respective images are based on at least one measurement which has been carried out during or at a brief temporal interval from the respective image acquisition.

In one development, the measurement signal is or has been generated by means of at least one image of the cooking product. The image is therefore incorporated into the generation of the measurement signature. In other words, the image of the cooking product represents an input dataset of measurement values for calculating the measurement signature. This embodiment results in the advantage that the measurement signature can map typical optically defined target processing states such as a degree of browning, degree of roasting, etc. in a particularly reliable and precise manner. The embodiment can be used particularly advantageously if the cooking appliance has at least one optical sensor such as a cooking chamber camera or another image acquisition apparatus for acquiring images of a cooking product disposed in the cooking chamber. A cooking chamber camera is understood in particular to be a camera which points into the cooking chamber, which is therefore configured to acquire images from the cooking chamber. The cooking chamber camera can be a camera integrated into the cooking appliance or a camera which is present outside the housing and points into the cooking chamber through a door window.

In one development, the measurement signature is the image itself. The reaching of the target measurement signature during a cooking process can be determined in one development by image comparison with actual images of the cooking product. This development results in the advantage that the image corresponds to the measurement signature and thus no separate measurement signature needs to be generated or saved.

Alternatively or in addition, the measurement signature can be at least one variable derived from the values of the pixels, for example an image channel-based histogram of the pixels (for example an RGB, HVB, NCS histogram, etc.), a degree of browning and/or degree of roasting determined from the pixels, where applicable in certain regions or segments, a height of the cooking product determined from the image, a spectral vector determined from the image, a feature vector, the result of what is known as a “machine learning” model, or any combination thereof.

In one alternative of the additional embodiment, the measurement signature is or has been generated at least by means of one non-optical sensor connected to a cooking chamber of the cooking appliance. In this way, the advantage is achieved that, in one development, the method can also be used with cooking appliances that do not have a cooking chamber camera.

Here, the desired target processing state is selected on the basis of images, but the measurement signature is created without the input of image data. In cooking appliances that have at least one cooking chamber camera, the advantage is achieved that a reaching of a target processing state can be determined in a particularly reliable manner. A non-optical sensor connected to a cooking chamber of the cooking appliance can be understood to mean a sensor which is arranged in the cooking chamber, projects into the cooking chamber, is connected to the cooking chamber from an air perspective, or can measure the characteristics of the cooking product and/or of the cooking chamber in some other way.

In one development, a non-optical sensor comprises at least one sensor from the group
cooking chamber temperature sensor,
core temperature sensor,
humidity sensor (for example lambda sensor),
oxygen sensor (for example lambda sensor),
chemical sensor for detecting predetermined chemical substances in the air of the cooking chamber.

The corresponding sensor measurement data can be used as input variables for calculating the measurement signature. The chemical sensor can detect for example volatile substances which are typically released from the cooking product as it browns.

In general, the measurement signature can therefore be calculated on the basis of one or several of the abovementioned optical and/or non-optical measurement variables.

In one embodiment, an initial measurement signature is determined on the basis of an image of the cooking product. As a result, the advantage is achieved that a residual cooking duration can be determined by linking the initial measurement signature to the target measurement signature. Linking can comprise comparing the target measurement signature with the initial measurement signature. In particular, empirically determined values can be stored for calculating the residual cooking duration, for example in the form of a lookup table.

In one embodiment, at least one new image (“preview image”) is generated from a set of images of the cooking product, which preview image shows a more advanced processing state of the cooking product than each of the images from the previous set, the at least one preview image is made available to a user for selection and, if a preview image is selected, the measurement signature associated with this preview image is calculated. As a result, the user is offered the option of choosing a processing state which is even further advanced than in the selectable images. The preview image can be generated for example by way of what are known as “auto-encoder methods”. The measurement signature associated with the selected preview image can be assumed as the target measurement signature for a subsequent cooking process. These pairs comprising a preview image and the measurement signature generated for it can be added to the existing set, if required together with an item of information pertaining to a time offset with respect to the last image or measurement signature of the existing set.

It is however also possible to treat a cooking product beyond the most advanced processing state of the existing set of images and then to acquire an image at a desired subsequent point in time (for example when the cooking appliance is switched off or the cooking product is removed) and to generate the associated measurement signature. This pair comprising an image and a measurement signature can then be added to the existing set, if required together with an item of information pertaining to the time offset with respect to the last image or measurement signature of the existing set. This results in the advantage that no preview image needs to be generated.

In one development, images of a cooking product are stored linked to their measurement signatures such that they can be retrieved. This achieves the advantage that images which can be selected by a user can be stored in at least one database for a multiplicity of cooking products. The sets of images stored in at least one database can comprise images generated for example by a manufacturer of the cooking appliance, a manufacturer of the cooking product, publishers of cookbooks/recipes, a user of the cooking appliance himself and or by other users (“user community”). For example, a manufacturer of the cooking appliance can have generated image sequences with corresponding measurement signatures in an experimental manner for certain cooking products and can make this data available in the database for users of cooking appliances. The at least one database can be integrated into the cooking appliance, into a user terminal device (for example a mobile user terminal device such as a smartphone, tablet PC, laptop PC, smart watch, etc. and/or also desktop PC) and/or in a network server and/or can be present as a cloud-based database.

If a cooking appliance has at least one cooking chamber camera, a particularly advantageous development is that the set of images is created by the cooking appliance during a cooking process and is saved with the associated measurement signatures such that it can be retrieved. In this way, a cooking product treatment created individually by a user can be made available for repeated cooking processes and if necessary shared with other users. The measurement signatures can be created by means of the cooking appliance itself or by means of an external entity such as a network server, a cloud computer, a user terminal device, etc.

In one embodiment, the set of images of the cooking product can be made available to the user for selection at a user interface of the cooking appliance and/or on a device external to the cooking appliance, which can in particular be capable of being coupled to the cooking appliance from a data perspective. In this way, a particularly user-friendly selection can be made available. In one development, the selection is offered to the user via an application program or “app” running on a mobile user terminal device. After selection of the image representing the desired processing state, the measurement signature can be transmitted from the database to the cooking appliance by means of the application program. It is advantageous for a particularly simple embodiment of the cooking appliance and/or of the user terminal device if the database is stored on a network server or in what is known as the “cloud”.

In one development, at least one operating setting of the cooking appliance is stored linked to the set of images. As a result, the residual cooking duration is advantageously predicted even more reliably and/or a reaching of the target processing state can be determined even more precisely. A further advantage lies in that a user is not only offered the set of images for selection but can also retrieve or display operating settings of the cooking appliance which are particularly suitable for a cooking process. The at least one operating setting can be input or made available by a user of the cooking appliance, other users, a manufacturer of the cooking appliance, manufacturers of cooking products and/or publishers of cookbooks/recipes, etc. The at least one operating setting of the cooking appliance can comprise for example a cooking product level, an activated operating mode, an activation or selection of a certain cooking program, etc. The operating mode can comprise for example a specification regarding at least one heating element activated for this purpose (for example bottom heating element, top heating element, hot air heating element, grill heating element, etc.), an activation and power of a microwave facility, etc.

In one development, a last selected image which is identified as such is stored in the stored set of images. This achieves the advantage that it is particularly easy for a user to recognize and select this image in order to select a target processing state. This is particularly advantageous if the last selected targeted processing state represents a successful processing result for the user.

The object is also achieved by a method for operating a cooking appliance in which a cooking operation or cooking process is carried out until a target processing state assumed by means of the method as described above is reached. This method can be embodied in an analogous manner to the above method and has the same advantages.

The reaching of the target measurement signature can be determined for example by comparing an actual measurement signature determined during the course of cooking with the target measurement signature.

In one development, at least one action is triggered when an actual measurement signature determined or calculated during a cooking process matches the target measurement signature at least within predefined limits or tolerances. This action can comprise for example outputting a message to a user, terminating the cooking process, a transition to a keep warm mode, etc. Outputting a message to a user can comprise outputting a “speaking” message to a screen of the cooking appliance, outputting a message (for example an SMS) to a user terminal device, outputting a signal tone to the cooking appliance and/or outputting a visual signal to the cooking appliance (for example causing a signal lamp to flash), etc.

In one embodiment, the cooking appliance is equipped with at least one optical sensor (for example at least one cooking chamber camera), an actual measurement signature is determined on the basis of at least one image of the cooking product acquired during a cooking process, and a residual cooking duration is determined by linking the actual measurement signature to the target measurement signature. This can take place in an analogous manner to the linking with the initial measurement signature.

In one embodiment, a progress indication is generated by linking the initial measurement signature, the actual measurement signature and the target measurement signature. In this way, the advantage is achieved that a user receives an even better overview of a progress of a processing of the cooking product. The progress indication can be for example a bar indication, the end points of which correspond to the initial measurement signature or the initial processing state and the target measurement signature or the target processing state.

The object is also achieved by a cooking appliance having a cooking chamber, at least one sensor connected to the cooking chamber, and a data processing facility, wherein the cooking appliance, in particular the data processing facility thereof, is designed to carry out a method as described above. The cooking appliance can be embodied in an analogous manner to the above method and has the same advantages.

In one development, the cooking appliance has at least one sensor from the group
cooking chamber camera,
cooking chamber temperature sensor,
core temperature sensor,
humidity sensor (for example lambda sensor),
oxygen sensor (for example lambda sensor),
chemical sensor for detecting predetermined chemical substances in the air of the cooking chamber.

The cooking appliance can have at least one user interface with a screen for displaying and selecting the images of the sets.

The cooking appliance can be equipped with at least one communication facility for data communication with external entities, for example a WLAN, Bluetooth, Ethernet or mobile radio module, etc. In this way, the advantage is achieved that the cooking appliance can be coupled from a data perspective to external entities such as user terminal devices, network servers, cloud computers or external databases. Specifically, once the user has selected a cooking product to be treated, the cooking appliance can download a corresponding set of images from an external database and then offer it for selection. The measurement signatures can be downloaded together with the images, or the associated measurement signature is downloaded after selection of an image and assumed as the target measurement signature. This enables a particularly simple and cost-effective implementation of the method.

The object is also achieved by a system, having a cooking appliance as described above, which is equipped with a communication facility for data communication with external entities, and having at least one device which is external to the cooking appliance and is in particular capable of being coupled to the cooking appliance from a data perspective via the communication facility. The external device can be for example a user terminal device, a network server, a cloud computer, an external database, etc. The system can be embodied in an analogous manner to the above methods and the cooking appliance and has the same advantages.

In one development, the system has the cooking appliance, a user terminal device, in particular a mobile user terminal device such as a smartphone, tablet PC, smart watch, etc., and a network-based database (such as a cloud-based database, a database integrated in a network server or the like). As a result, the advantage is achieved that a particularly user-friendly execution of the method can be implemented. In particular, this development makes it possible for
a user to select a particular cooking product (possibly in the form of a recipe) for treatment after launching an application program on his mobile user terminal device,
a set of images associated with the cooking product thereupon to be loaded from a network-based database onto the mobile user terminal device and displayed to a user for selection,
a corresponding measurement signature to be transmitted to the cooking appliance, possibly together with the associated operating settings following selection by the user, directly from the database or indirectly via the mobile user terminal device,
the received measurement signature to be assumed by the cooking appliance as the target measurement signature, possibly together with the associated operating settings,
a cooking process to be carried out on the cooking appliance, in which an actual measurement signature is continuously compared with the target measurement signature, and
at least one action to be triggered if the actual measurement signature matches the target measurement signature at least within predetermined limits or tolerances.

The object is further achieved by a computer program product, comprising commands which, when the program is executed by at least one data processing facility, prompt said data processing facility to carry out a method as described above. The computer program product can comprise an app which can run on a user terminal device and/or a program running on a data processing facility of the cooking appliance.

The above-described properties, features and advantages of this invention and the manner in which these are achieved will become clearer and more readily understandable in connection with the following schematic description of an exemplary embodiment, which will be described in further detail making reference to the drawings.

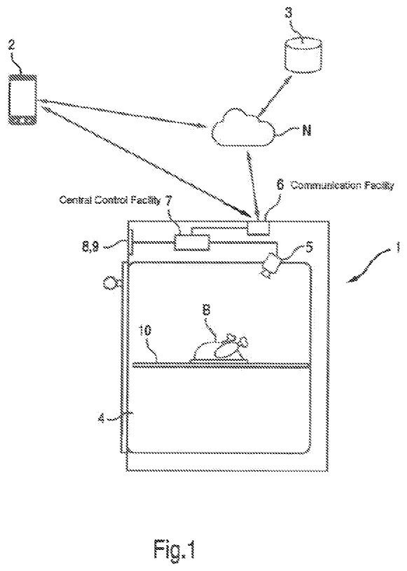

FIG. 1 shows an outline drawing of a system, having a cooking appliance which is equipped with a communication facility for data communication with external entities, and having at least one device which is external to the cooking appliance and can be coupled to the cooking appliance from a data perspective via the communication facility; and

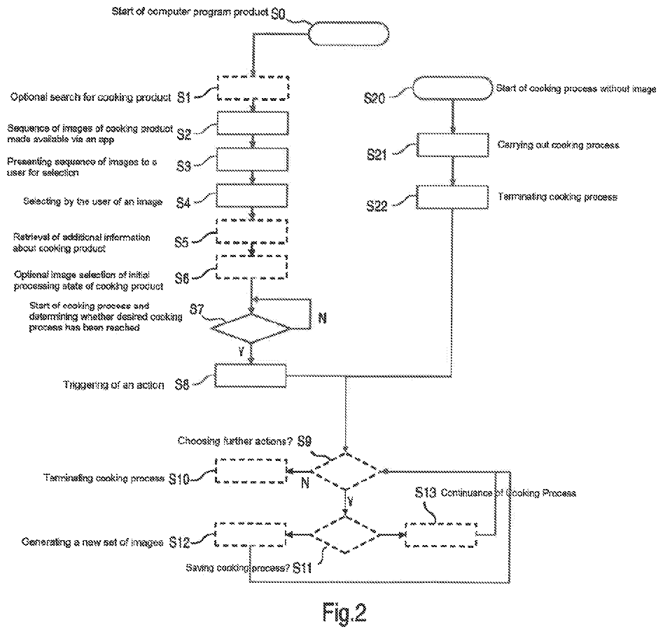

FIG. 2 shows a method sequence for operating the system.

FIG. 1 shows an outline drawing of a system 1 to 10 with a cooking appliance in the form of an oven 1, a device external thereto, in particular a user terminal device such as here in the form of a smartphone 2, and an external device in the form of at least one network-based database 3. The oven 1 has a heatable cooking chamber 4, a cooking chamber camera 5 pointing into the cooking chamber 4, a communication facility 6 in the form of a WLAN, Bluetooth or Ethernet module, for example, a data processing apparatus in the form of a central control facility 7, and a user interface 8 with a screen 9. The smartphone 2 is capable of being coupled to the database 3 from a data perspective via a network N, such as the Internet. The smartphone 2 is further capable of being coupled to the communication facility 6 from a data perspective via the network N and/or directly. Furthermore, the communication facility 6 is capable of being coupled to the database 3 from a data perspective via the network N. Here in the cooking chamber 4, a cooking product in the form of a roasting chicken B is introduced via a cooking product carrier 10 at a certain cooking product level.

The database 3 can comprise several databases, for example a database of a manufacturer of the oven 1, a database of a producer of the roasting chicken B, a recipe database of a publisher and/or the user's own database.

FIG. 2 shows a method sequence for operating the system 1 to 10 for the case that a user wishes to prepare a known cooking product, namely here the roasting chicken B, in the oven 1.

To this end, in a step S0 the user starts a corresponding computer program product or a part thereof in the form of an application program or “app” on the smartphone 2. Alternatively, any other suitable user terminal device such as a tablet PC, laptop PC, desktop PC, etc. can also be used instead of the smartphone. In one variant, in addition or as an alternative to the use of a user terminal device, the communication with the user and/or the control of the method sequence can take place via the user interface 8 of the oven 1.

In an optional step S1, the user uses the app to search through a list, a photo album or the like of known cooking products for the entry “roasting chicken” and then selects this entry. Alternatively, the user can initiate a search query via voice control. Alternatively, the cooking product can be detected automatically as a roasting chicken B.

In a step S2, the app causes a sequence of images of the roasting chicken B in various processing states to be made available for selection, if available, from the at least one database 3. In the case of the roasting chicken B, the processing state typically corresponds to a degree of browning.

In a step S3, the sequence of images is presented to the user for selection on the smartphone 2. The images of the sequence of images can be represented individually, as a group, as a time-lapse video, etc.

If the smartphone 2 establishes in a step S4 that one of the images has been selected, it causes the measurement signature (here: the degree of browning) which has been stored or saved in the database 3 linked to the selected image to be transmitted to the oven 1. The oven 1 then assumes the transmitted measurement signature as the target measurement signature.

In an optional step S5, the smartphone 2 retrieves additional information, in particular operating settings, of the oven 1 which are linked to the selected roasting chicken B in the database, for example a preferred slide-in level, a preferred cooking chamber temperature, a preferred selection of heating elements or operating modes, etc. In one development, the operating setting can also be transmitted to the oven 1 and automatically assumed by the same so that a user does not need to set this operating setting himself on the oven.

Before or at the start of a cooking process, a user can use the application program to select an image that most closely approximates the initial processing state of the roasting chicken, which is indicated here as an optional step S6. The selection can take place on the basis of the downloaded images from the set. Alternatively, the user can use the smartphone 2 to acquire an image of the as yet untreated roasting chicken B. In yet another variant, the user can use the cooking chamber camera 5 to acquire an image of the as yet untreated roasting chicken B. The initial measurement signature linked to this image can be calculated in the oven 1 or calculated externally thereto and then transmitted to the oven 1.

In a step S7, a user starts a cooking process for roasting the roasting chicken B, which cooking process is controlled by the control facility 7. The oven 1 can thereby be heated to a target cooking chamber temperature by means of set heating elements (top figure), for example. The operating setting can be made manually by a user or assumed automatically from the database 3 for the roasting chicken B selected in step S1 if these operating settings have also been transmitted to the oven 1.

In step S7, the cooking chamber camera 5 acquires images of the roasting chicken B at temporal intervals (for example of 10 s, 30 s, 1 min, etc.). For each image, an actual measurement signature is generated by means of the control facility 7 or a computer external to the appliance. Here, it is possible for example to calculate an actual degree of browning in a generally known manner from the lightness and/or from a color change of the surface of the roasting chicken B and to compare this with the target degree of browning assumed from the database 3.

The images can generally be acquired in a temporally equidistant or temporally variable manner, for example in an event-driven manner. In one development, successive images can thus be acquired or used for the method only if they have a sufficiently different degree of processing, for example degree of browning. This can be implemented such that the set of images comprises only images in which directly successive images have a sufficiently different measurement signature.

If the target degree of browning is not yet reached (“N”), the cooking process is continued. If the target degree of browning is reached (“Y”), an action is triggered in a step S8 by means of the control facility 7, for example the heating element is deactivated and/or at least one message or indication is output to the user. The action can comprise a deactivation of the heating element or a transition to a keep warm mode at a low cooking chamber temperature.

In step S7, a residual cooking duration can optionally be determined by linking the initial measurement signature determined in step S6 to the actual measurement signature and/or the target measurement signature.

In an optional step S9, the user can choose whether he would like to carry out further actions. If this is not the case (“N”), the cooking process is finally terminated in a step S10. If the action carried out in step S8 comprised a deactivation of the heating element, this remains deactivated. If the action carried out in step S8 comprised a transition to a keep warm mode at a low cooking chamber temperature, the heating elements are now deactivated. Alternatively or in addition, a door opening of the cooking chamber 4 can be interpreted as a wish of the user to terminate the cooking process. The heating elements can therefore be deactivated if the door is opened.

If, on the other hand, the user wishes to carry out further actions (“Y”), he is offered the choice whether to (a) save the cooking process which has just been carried out as a new cooking product or (b) start a subsequent cooking process. The user may wish to save the cooking process which has just been carried out as a new cooking product, for example if the roasting chicken B has undergone special processing in comparison to the cooking product selected using the smartphone 2 and/or has been prepared in a specific manner (has been coated with a barbecue sauce, for example). A subsequent cooking process may be desired, for example, if the highest degree of browning available for selection from the images proved to be insufficient.

If the user has chosen to save the cooking process as a new cooking product in step S11 (“Y1”), a new set of images is generated automatically in a step S12 from the images generated during the cooking process and saved in the database together with the measurement signatures generated in each case (here: degrees of browning), in particular after the user has assigned a new name (for example “barbecue roast chicken”). Information which has been queried automatically or input by a user such as operating parameters, preparation instructions, recipes, etc. can optionally also be saved in the database 3. In one variant, the data saved in the database 3 can be released for searching and saving by other users (“community”). The method then branches back to step S9.

If the user has chosen a subsequent cooking process in step S11, the cooking process can be continued in a step S13 with further heating until the user interrupts the cooking process himself, a subsequent cooking duration set by the user has expired, or a degree of browning calculated during the subsequent cooking process by means of preview images has been reached. The method then branches back to step S9.

In one development, the cooking chamber camera 5 acquires images of the roasting chicken B at temporal intervals (for example of 10 s, 30 s, 1 min, etc.) in an analogous manner to step S7. If, after the method has branched back to step S9, the user chooses to save the cooking process that has just been carried out as a new cooking product, the images and measurement signatures generated during the subsequent cooking process can be appended to the images and measurement signatures generated in step S7 during the regular cooking process.

In one development, the cooking chamber camera 5 acquires an image of the roasting chicken B when the subsequent cooking process is interrupted (by the user or when the subsequent cooking duration expires) and appends this image with the associated measurement signature to the images and measurement signatures generated in step S7 during the regular cooking process, either automatically or after confirmation by the user. Specifically, this image can be saved together with an item of information indicating that this image corresponded to a target measurement signature in the cooking process.

In one development, preview images with a higher degree of browning can be calculated or simulated and offered for selection during the subsequent cooking process. If a user selects a particular preview image, the degree of browning is calculated therefrom as a target measurement signature and assumed for the subsequent cooking process. The calculation of the preview image can be calculated in particular on the basis of the images acquired in step S7 during the cooking process.

In a step S20, a user can optionally start a cooking process, for example to roast the roasting chicken B, without previously making an image-based selection of a target processing state, for example by manually setting an operating setting (for example an operating mode and a target cooking chamber temperature).

In a step S21, the cooking process is carried out until it is terminated in a step S22 either manually by a user or after the end of a cooking duration which was set at the start in step S20.

In one development, in step S21 the cooking chamber camera 5 acquires images of the roasting chicken B at temporal intervals (for example of 10 s, 30 s, 1 min, etc.) in an analogous manner to step S7. For each image, a measurement signature is generated by means of the control facility 7 or a computer external to the appliance. Here, it is possible for example to calculate a degree of browning in a generally known manner from the lightness and/or from a color change of the surface of the roasting chicken B. The acquisition of the images or the sequence of images can be initiated automatically or have been defined by a user with step S20. At the end of the cooking process in step S22, the image acquisition is then also terminated.

Step S22 can be followed by step S9 if a sequence of images with associated measurement signatures has been generated during the cooking process in step S21.

The described method results in the following advantages, among others:
Instead of abstract scales (for example with regard to the degree of browning) which are difficult to understand, browning results are visualized in a manner which is easy for the user to understand.
The user can easily set a reproducible degree of browning or roasting of the surface of the cooking product.
The reproducibility of the cooking results on the basis of the measurement signature prevents an over-browning of the cooking product.
Recipes with a predefined browning progress and an appliance controller can be linked easily.
A display of the residual cooking duration (for example via status bars or as a time value) is possible during the roasting progress, as with a known initial measurement signature and/or actual measurement signature the deviation from the target measurement signature is known.
User feedback regarding the roasting results can be used to improve existing models.
The cooking chamber camera is provided with a meaningful sensor function.

Naturally, the present invention is not restricted to the exemplary embodiment shown.

The acquired images can thus also be used as measurement signatures themselves, as a result of which a calculation of separate measurement signatures can be dispensed with.

Furthermore, a vector generated by means of a machine learning algorithm can be used as a measurement signature, for example. The respective images of the set and possibly further measurement data can be used as input variables for the machine learning algorithm, for example.

Advantageously, extended regulation options can also be provided for dishes, if the oven has further, non-optical sensors, in that for example a core temperature, an oxygen content etc. is detected and adhered to in order to achieve the desired result. The measurement values of the non-optical sensors can but do not have to be incorporated into the measurement signature. The measurement values of the non-optical sensors can generally be monitored in addition to or in parallel with the measurement signature to determine whether tolerance or target states have been reached.

In general, “a”, “an”, etc. can be understood as singular or plural, in particular in the sense of “at least one” or “one or more”, etc., provided this is not explicitly excluded, for example by the expression “precisely one”, etc.

A numerical value can also include the given value as well as a typical tolerance range, provided this is not explicitly excluded.

### LIST OF REFERENCE CHARACTERS

1 Oven
2 Smartphone
3 Database
4 Cooking chamber
5 Cooking chamber camera
6 Communication facility
7 Control facility
8 User interface
9 Screen
10 Cooking product carrier
B Roasting chicken
N Network
S0-S22 Method steps

1.-12. (canceled)

13. A method for determining a target processing state of a cooking product to be treated using a cooking appliance, said method comprising:
providing a set of images of the cooking product in different processing states to a user, with measurement signatures being stored for the images, and
when the user selects one of the images, assuming by the cooking appliance a corresponding one of the measurement signatures associated with the selected image as a target measurement signature.

14. The method of claim 13, wherein the measurement signature is generated by an image of the cooking product.

15. The method of claim 13, wherein the measurement signature is generated by a non-optical sensor connected to a cooking chamber of the cooking appliance.

16. The method of claim 13, further comprising:
generating a preview image from the set of images of the cooking product, with the preview image showing a more advanced processing state of the cooking product than each of the images from the set of images; and
providing the preview image to the user for selection; and
calculating a measurement signature associated with the preview image, when the preview image is selected.

17. The method of claim 13, wherein the set of images of the cooking product is made available to the user for selection at a user interface of the cooking appliance and/or on a device external to the cooking appliance, which device is coupled to the cooking appliance by data connection.

18. The method of claim 13, further comprising:
determining an initial measurement signature on the basis of an image of the cooking product; and
determining a residual cooking duration by linking the initial measurement signature to the target measurement signature.

19. A method for operating a cooking appliance, said method comprising carrying out a cooking process by the cooking appliance until reaching a target measurement signature provided by a method as set forth in claim 13:

20. The method of claim 19, further comprising:
acquiring the set of images of the cooking product with an optical sensor of the cooking appliance;
determining an actual measurement signature on the basis of the image of the cooking product acquired during a cooking process; and
determining a residual cooking duration by linking the actual measurement signature to the target measurement signature.

21. The method of claim 19, further comprising determining a residual cooking duration, and/or generating a progress indication by linking an initial processing state, an actual processing state and a target processing state.

22. A cooking appliance, comprising:
a cooking chamber;
a sensor connected to the cooking chamber; and
a data processing facility configured to control a cooking process by providing a set of images of a cooking product in the cooking chamber in different processing states to a user, with measurement signatures being stored for the images, and when the user selects one of the images, assuming by the cooking appliance a corresponding one of the measurement signatures associated with the selected image as a target measurement signature.

23. A system, comprising:
a cooking appliance as set forth in claim 22, said cooking appliance comprising a communication facility; and
a device external to the cooking appliance and coupled to the communication facility of the cooking appliance by a data connection for data communication with the device.

24. A computer program product, comprising a computer program embodied in a non-transitory computer readable medium and storing commands which, when the computer program is executed by a data processing facility, prompt the data processing facility to carry out a method as set forth in claim 13.

25. A computer program product, comprising a computer program embodied in a non-transitory computer readable medium and storing commands which, when the computer program is executed by a data processing facility, prompt the data processing facility to carry out a method as set forth in claim 19.

26. A method for operating a cooking appliance, said method comprising:
selecting by a user an image from a set of images of the cooking product in different processing states; and
carrying out a cooking process by the cooking appliance until reaching a target measurement signature commensurate with a measurement signature stored for the image.

27. The method of claim 26, further comprising:
acquiring the set of images of the cooking product with an optical sensor of the cooking appliance;
determining the measurement signature on the basis of the image of the cooking product acquired during a cooking process; and
determining a residual cooking duration by linking the measurement signature to the target measurement signature.
